(19) United States
(12) Patent Application Publication
(10) Pub. No.: US 2024/0037569 A1
(43) Pub. Date: Feb. 1, 2024

(54) INFORMATION PROCESSING DEVICE, AND INFORMATION PROCESSING METHOD

(71) Applicant: Mitsubishi Electric Corporation, Tokyo (JP)

(72) Inventor: Shinji MAEDA, Tokyo (JP)

(73) Assignee: Mitsubishi Electric Corporation, TOKYO (JP)

(21) Appl. No.: 18/379,725

(22) Filed: Oct. 13, 2023

Related U.S. Application Data
(63) Continuation of application No. PCT/JP2021/016999, filed on Apr. 28, 2021.

(51) Int. Cl. G06Q 30/018; G06Q 30/0283

(52) U.S. Cl. CPC G06Q 30/018; G06Q 30/0283

(57) ABSTRACT

An information processing device includes an acquisition unit that acquires input information indicating correspondence relationship between a plurality of items regarding one or more products and a plurality of pieces of information, a standard judgment table as information indicating a standard of each of the plurality of items, and a past case example table as information indicating a past case example regarding each of the plurality of items, a detection unit that detects a non-standard item, as an item in which corresponding information is non-standard, out of the plurality of items based on the standard judgment table and the plurality of pieces of information, and a search unit that searches for a past case example regarding the non-standard item by using the past case example table.

### CROSS-REFERENCE TO RELATED APPLICATION

This application is a continuation application of International. Application No. PCT/JP2021/016999 having an international filing date of Apr. 28, 2021.

### BACKGROUND OF THE INVENTION

### 1. Field of the Invention

The present disclosure relates to an information processing device, and an information processing method.

### 2. Description of the Related Art

There are cases where a device performs an estimation. When performing an estimation, it is possible to employ a method using past case examples. Here, a technology for extracting past case examples has been proposed (see Patent Reference 1). For example, when requirement information is received, a design diversion support device in the Patent Reference 1 extracts design information (i.e., past case examples), associated with requirement specification information regarding a requirement specification similar to a requirement specification indicated by the requirement information, as a diversion candidate. Incidentally, the judgment of similarity between the requirement specifications is made based on the Hamming distance between the requirement specification items.
Patent Reference 1: Japanese Patent Application Publication No. 2016-76012

In the above-described technology, the judgment of similarity is made by using all of the requirement specification items. Thus, in the above-described technology, there are cases where a desired past case example cannot be acquired.

### SUMMARY OF THE INVENTION

An object of the present disclosure is to acquire a desired past case example.

An information processing device according to an aspect of the present disclosure is provided. The information processing device includes an acquisition unit that acquires input information indicating correspondence relationship between a plurality of items regarding one or more products and a plurality of pieces of information, standard judgment information as information indicating a standard of each of the plurality of items, and past case example information as information indicating a past case example regarding each of the plurality of items, a detection unit that detects a non-standard item, as an item in which corresponding information is non-standard, out of the plurality of Items based on the standard judgment information and the plurality of pieces of information, and a search unit that searches for a past case example regarding the non-standard item by using the past case example information.

According to the present disclosure, a desired past case example can be acquired.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in an information processing device in a first embodiment;

FIG. 2 is a block diagram showing functions of the information processing device in the first embodiment;

FIG. 3 is a diagram showing an example of a standard judgment table in the first embodiment;

FIG. 4 is a diagram showing an example of a past case example table in the first embodiment;

FIG. 5 is a flowchart showing an example of a process executed by the information processing device in the first embodiment;

FIG. 6 is a diagram showing a concrete example (No. 1) of an estimation process in the first embodiment;

FIG. 7 is a diagram showing a concrete example (No. 2) of the estimation process in the first embodiment;

FIG. 8 is a block diagram showing functions of an information processing device in a second embodiment;

FIG. 9 is a flowchart (No. 1) showing an example of a process executed by the information processing device in the second embodiment; and

FIG. 10 is a flor chart (No. 2) showing the example of the process executed by the information processing device in the second embodiment.

### DETAILED DESCRIPTION OF THE INVENTION

Embodiment described below with reference to the drawings. The following embodiments are just examples and a variety of modifications are possible within the scope of the present disclosure.

### First Embodiment

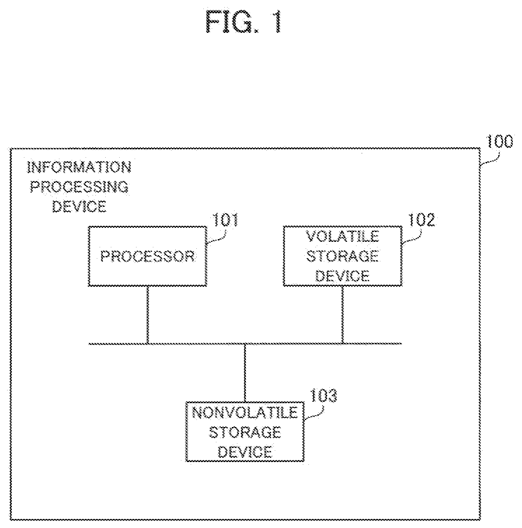

FIG. 1 is a diagram showing hardware included in an information processing device to a embodiment. The information processing device 100 is device that executes an information processing method. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include a processing circuitry. The processing circuitry may be either a single circuit or a combined circuit.

The volatile storage device 102 is main storage of the information processing device 100. The volatile storage device 102 is a Random Access Memory (RAM), for example. The nonvolatile storage device 103 is auxillary storage of the information processing device 100. The nonvolatile storage device 103 is a Hard Disk Drive (HDD) or a Solid State Drive (SSD), for example.

Next, functions included in the information processing device 100 will be described below.

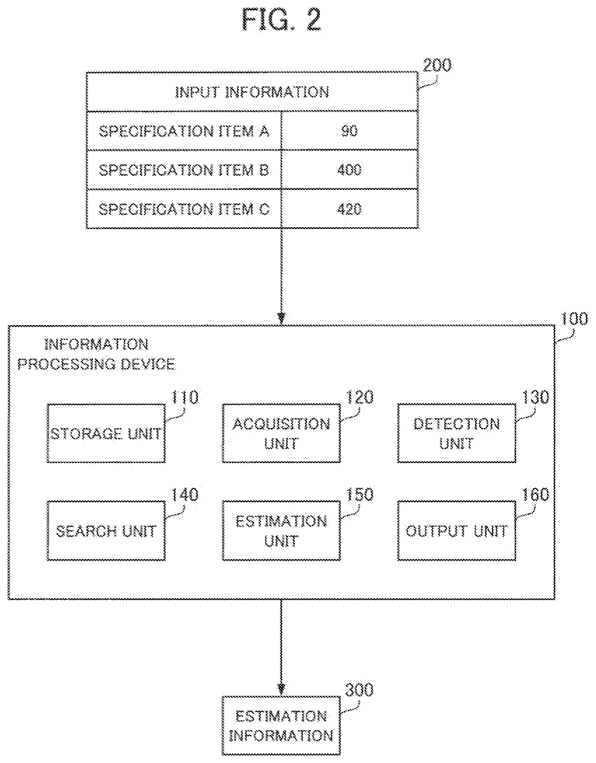

FIG. 2 is a block diagram showing the functions of the information processing device in the first embodiment. The information processing device 100 includes a storage unit 110, an acquisition unit 120, a detection unit 130, a search unit 140, an estimation unit 150 and an output unit 160.

The storage unit 110 may be implemented as a storage area reserved in the volatile storage device 102 or the nonvolatile storage device 103.

Part of all of the acquisition unit 120, the detection unit 130, the search unit 140, the estimation unit 150 and the output unit 160 may be implemented by a processing circuitry. Further, part or all of the acquisition unit 120, the detection unit 130, the search unit 140, the estimation unit 150 and the output unit 160 may be implemented as modules of a program executed by the processor 101. For example, the program executed by the processor 101 is referred to also as an information processing program. The information processing program has been recorded in a record medium, for example.

The storage unit 110 may store a standard judgment table and a past case example table. The standard judgment table and the past case example table will be described in detail later.

The acquisition unit 120 acquires input information 200. For example, the acquisition unit 120 acquires the input information 200 generated by an input operation performed on the information processing device 100 by a user.

The input information 200 is information indicating correspondence relationship between a plurality of items regarding one or more products and a plurality of pieces of information. The plurality of items may be represented also as a plurality of items regarding design of one or more products. The plurality of items may be represented also as a plurality of items indicating information necessary when making one or more products. Further, the plurality of pieces of information can also be numbers, characters or the like.

When the product is a car of an elevator, the plurality of items are a length, a width and a height of the car. When the product is the car, the plurality of pieces of information are values indicating the length, the width and the height of the car.

FIG. 2 indicates that specification items A, B and C are included in the input information 200. For example, the specification items A, B and C may be regarded as the length, the width and the height of the car of the elevator.

Further, in the case where the product is the car of the elevator, one item among the plurality of items is an item regarding a mirror in the car, for example. Then, one piece of information among the plurality of pieces of information is information regarding whether or not the mirror should be installed in the car. For example, when the mirror should be installed in the car, the one piece of information represents “1” as information indicating that the mirror should be installed in the car. When the mirror should not be installed in the car, the one piece of information represents “0” as information indicating that the mirror Should not be installed in the car.

The acquisition unit 120 acquires the standard judgment table. For example, the acquisition unit 120 acquires the standard judgment table from the storage unit 110. Incidentally, the standard judgment table may also be stored in an external device (e.g., cloud server). In the case where the standard judgment table is stored in an external device, the acquisition unit 120 acquires the standard judgment table from the external device. Here, an example of the standard judgment table will be shown below.

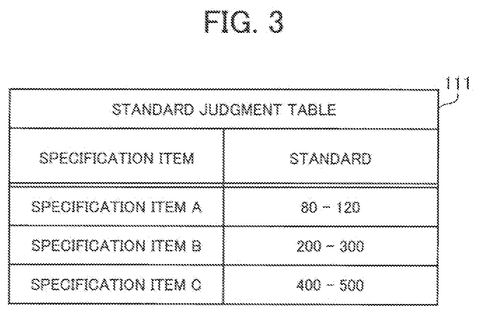

FIG. 3 is a diagram showing an example of the standard judgment table in the first embodiment. For example, the standard judgment table 111 has been stored in the storage unit 110. The standard judgment table 111 is referred to also as standard judgment information. The standard judgment table 111 includes items of specification item and standard. The specification items A, B and C have been registered in the SPECIFICATION ITEM in FIG. 3. For example, the specification items A, B and C may be regarded as the length, the width and the height of the car of the elevator. For example, in the case where the specification item A is the length of the car of the elevator, FIG. 3 indicates the standard of the longitudinal length of the car is “80-120”. Incidentally, it is also possible to register a standard value or a character representing the standard in the Item of standard.

As above, information indicating the standard of each of the plurality of items included in the input information 200 has been registered in the standard judgment table 111.

The acquisition unit 120 acquires the past case example table. For example, the acquisition unit 120 acquires the past case example table from the storage unit 110. Incidentally, the past case example table may also be stored in an external device. In the case where the past case example table is stored in an external device, the acquisition unit 120 acquires the past case example table from the external device. Bare, an example of the past case example table will be shown below.

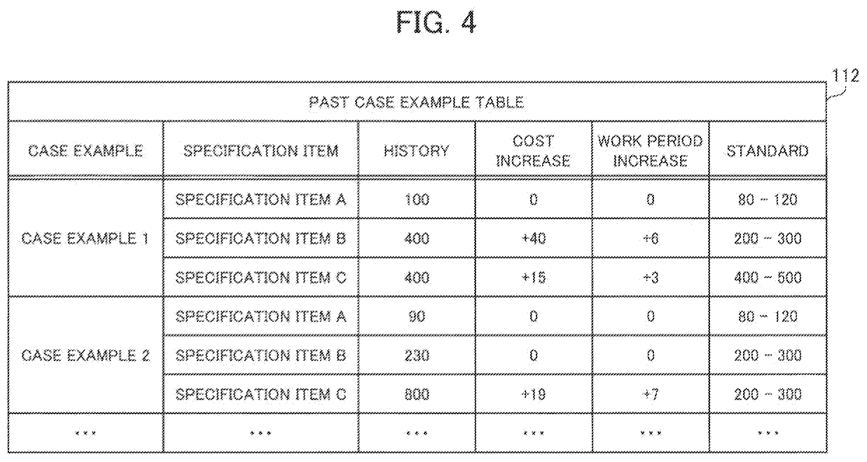

FIG. 4 is a diagram showing an example of the past case example table in the first embodiment. For example, the past case example table 112 has been stored in the storage unit 110. The past case example table 112 is referred to also as past case example information. The past case example table 112 includes items of case example, specification item, history, cost rise, work period increase and standard.

In the item of case example, an identifier of a past case example is registered. In the item of specification item, information regarding one or more products is registered. In the item of history, a history record in the past case example is registered. For example, in the case where the specification item A is the length of the car of the elevator, FIG. 4 indicates that the length of the car at the time of the “case example 1” was “100”. In the item of cost increase, cost relative to the cost at a reference value is registered. In the item of work period increase, a work period relative to the work period at a reference value is registered. In the item of standard, information indicating the standard is registered.

Incidentally, the item of cost increase may be replaced with an item of cost. In the item of cost, a sum total of the cost at the reference value and the cost indicated by the cost increase is registered. The item of work period increase m replaced with an item of work period. In the item of work period, a sum total of the work period at the reference value and the work period indicated by the work period increase is registered.

As above, information indicating past case examples regarding each of the plurality of items included in the input information 200 has been registered in the past case example table 112. Further, each of the plurality of past case examples included in the past case example table 112 includes at least one of the cost regarding a corresponding item and the work period regarding the corresponding item.

The functions of the detection unit 130, the search unit 140, the estimation unit 150 and the output unit 160 will be described in detail later.

Next, a process executed by the information processing device 100 will be described below by using a flowchart.

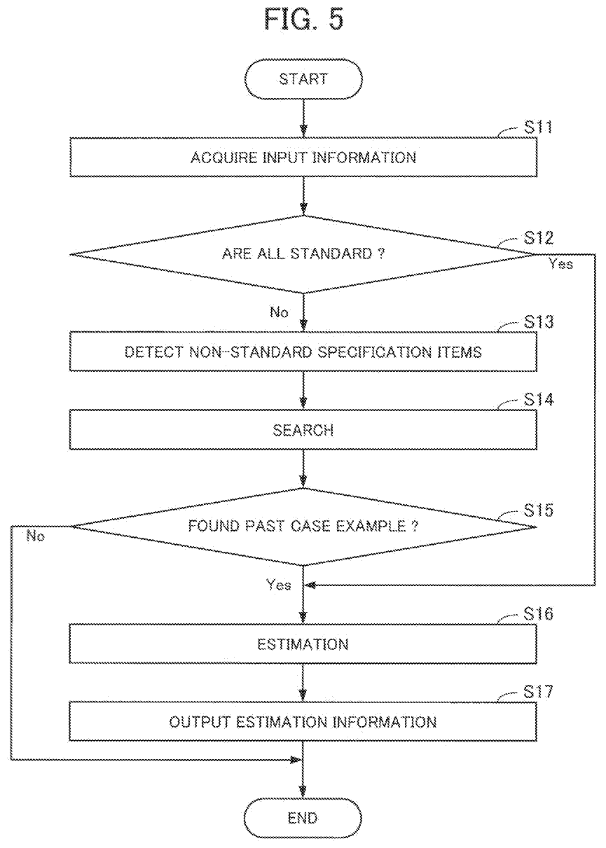

FIG. 5 is a flowchart showing an example of the process executed by the information processing device in the first embodiment.

(Step S11) The acquisition unit 120 acquires the input information 200. It is assumed here that the input information 200 includes values corresponding respectively to the specification items A, B and C.

(Step S12) The detection unit 130 judges whether all of the values corresponding respectively to the specification items A, B and C indicated by the input information 200 are standard or not based on the standard judgment table 111. When all of the values are standard, the process advances to step S16. When at least one of the values is not standard, the process advances to step S13.

(Step S13) The detection unit 130 detects one or more non-standard specification items out of the specification items A, B and C indicated by the input information 200. In short, the detection unit 130 detects specification items having non-standard values out of the specification items A, B and C indicated by the input information 200. The detected non-standard specification item is assumed to be the specification item B. Incidentally, a non-standard specification item may be referred to also as a non-standard item.

As above, the detection unit 130 detects the non-standard specification item as the item in which the corresponding information is non-standard out of the plurality of items included in the input information 200 based on a plurality of pieces of information included in the input information 200 and the standard judgment table 111.

(Step S14) The search unit 140 searches for the past case examples regarding the non-standard specification items by using the past case example table 112. In other words, the search unit 140 searches the past case example table 112 for the past case examples regarding the non-standard specification items. For example, the search unit 140 finds the specification item B in the case example 1 and the specification item B in the case example 2.

(Step S15) The search unit 140 judges her or not a past example has been found by the search. When a past case example has been found by the search, the process advances to the step S16. When no past case example has been found by the search, the process ends.

(Step S16) When the step S16 is executed after the step S15, the estimation unit 150 estimates at least one of the cost regarding the non-standard specification item and the work period regarding the non-standard specification item based on the past case example found by the search.

When the step S16 is executed after the step S12, the estimation unit 150 estimates at least f the one c cost and the work period based on at least one of a standard cost and a standard work period that have been set previously.

(Step S17) The output unit 160 outputs estimation information 300 as information obtained by the estimation. For example, the output unit 160 outputs the estimation information 300 to a display connected to the information processing device 100.

For example, the co included in the estimation information 300 may be outputted in the form (e.g., “+40”) of a cost relative to the cost at the reference value. The cost included in the estimation information 300 may be outputted as a sum total of the cost at the reference value and the cost indicated by the cost increase.

Further, for example, the work period included in the estimation information 300 may be outputted in the form (e.g., “+6”) of a work period relative to the work period at the reference value. The work period included in the estimation information 300 may be outputted as a sum total of the work period at the reference value and the work period indicated by the work period increase.

Next, concrete examples of an estimation process will be described below.

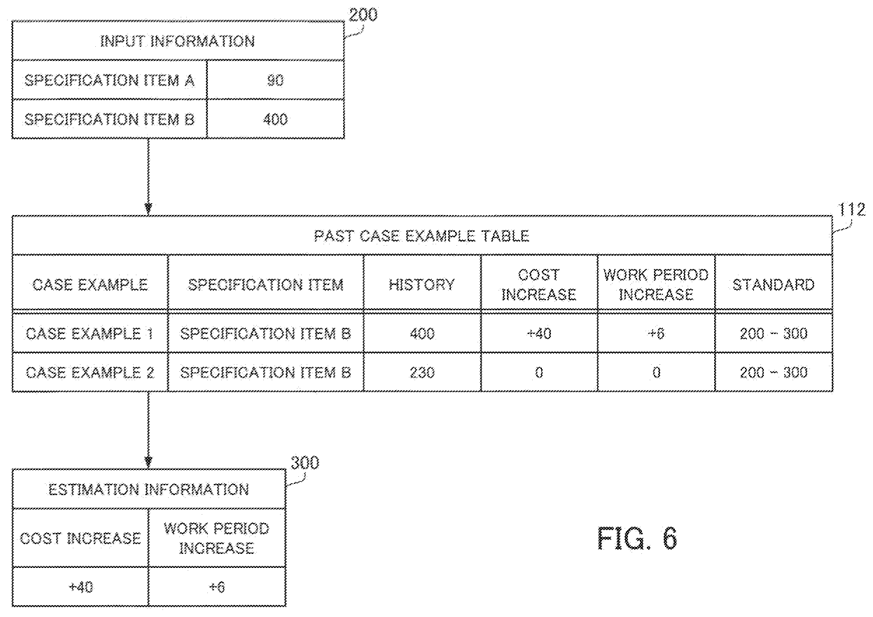

FIG. 6 is a diagram showing a concrete example (No. 1) of the estimation process in the first embodiment. The input information 200 includes values corresponding respectively to the specification items A and B. Since the value “400” corresponding to the specification item B is not standard, the detection unit 130 detects the specification item B as a non-standard specification item. The search unit 140 searches for the past casa examples regarding the specification item B by using the past example table 112. By this search, the search unit 140 finds the specification item B in the case example 1 and the specification item B in the case example 2.

Based on the result of the search, the estimation unit 150 detects the history record “400” in the record of the specification item B in the case example 1 having the same value as the value “400” corresponding to the specification item B in the input information 200. The estimation unit 150 estimates the cost increase “+40” and the work period “+6” in the record of the specification item B in the case example 1 as the cost and the work period.

The output unit 160 outputs the estimation information 300.

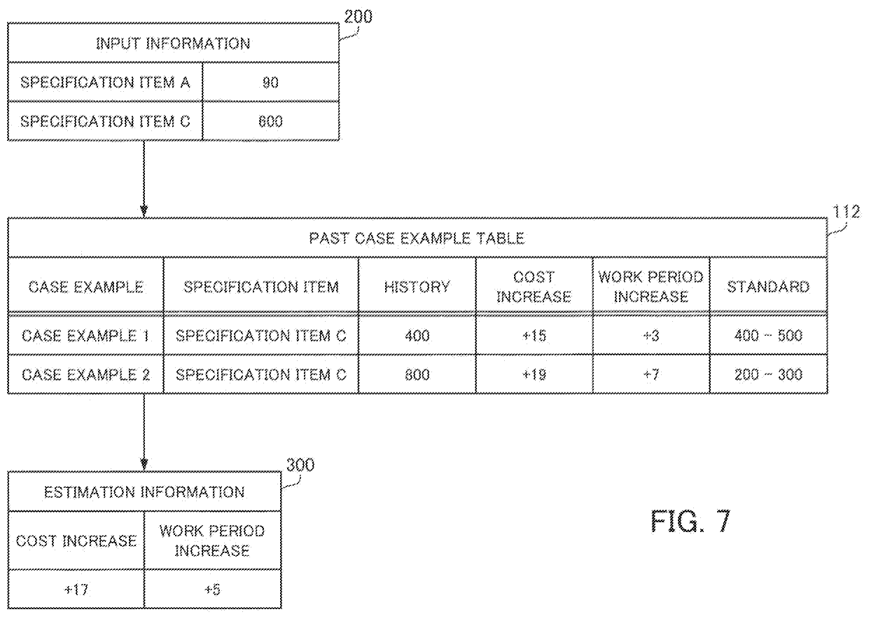

FIG. 7 is a diagram showing a concrete example (No. 2) of the estimation process in the first embodiment. The input information 200 includes values corresponding respectively to the specification items A and C. Since the value corresponding to the specification item C is not standard, the detection unit 130 detects the specification item C as a non-standard specification item. The search unit 140 searches for the past case examples regarding the specification item C by using the past case example table 112. By this search, the search unit 140 finds the specification item C in the case example 1 and the specification item C in the case example 2.

Here, in the concrete example (No. 2), a description will be given of a case where the result of the search does not include information that is the same as a value corresponding to the specification tem C (i.e., non-standard specification item). First, based on the result of the search, the estimation unit 150 detects that there exists no history record having the same value as the value “600” corresponding to the specification item C in the input information 200. The estimation unit 150 detects that “600” is a value between history record “400” in the record of the specification item C in the case example 1 and the history record “800” in the record of the specification item C in the case example 2. The estimation unit 150 estimates a value “+17” between the cost increase “+15” in the record of the specification item C in the case example 1 and the cost increase “+19” in the record of the specification item C in the e example 2 as the cost. The estimation unit 150 estimates a value “+5” between the work period increase “3” in the record of the specification item C in the case example 1 and the work period increase “+7” in the record of the specification item C in the case example 2 as the work period.

The output unit 160 outputs the estimation information 300.

As above, the information processing device 100 performs the estimation automatically. Therefore, the information processing device 100 is capable of reducing the load on the user for performing the estimation.

Here, in the case where the result of the search does not include information that is the same as a value corresponding to a non-standard specification item, the information processing device 100 may also execute the following process. First, the acquisition unit 120 acquires a learned model. For example, the acquisition unit 120 acquires the learned model from the storage unit 110. Alternatively, the acquisition unit 120 acquires the learned model from the external device, for example.

When the result of the search does not include information that is the same as information corresponding to a non-standard specification item, the estimation unit 150 estimates at least one of the cost and the work period by using the information corresponding to the non-standard specification item and the leaned model. As above, when the information corresponding to the non-standard specification item is inputted, the leaned model outputs at least one of the cost and the work period. Here, the leaned model is a leaned model generated by executing learning for outputting at least one of a precise cost and a precise work period. Therefore, the information processing device 100 is capable of estimating at least one of a precise cost and a precise work period by using the leaned model.

Here, in the Patent Reference 1, the judgment of similarity is made by using all of the requirement specification items. Accordingly, there is a possibility of extracting a past case example irrelevant to a non-standard specification item even when the non-standard specification item is included in the requirement specification items. Thus, in the technology of the Patent Reference 1, there are cases where a desired past case example cannot be acquired.

According to the first embodiment, the information processing device 100 detects a non-standard specification item by using the standard judgment table 111 and searches for past case examples regarding the non-standard specification item by using the past case example table 112. Thus, the information processing device 100 is capable of acquiring a desired past case example.

Further, the information processing device 100 acquires the past case examples regarding the non-standard specification item by using the standard judgment table 111 and the past case example table 112 without using the Hamming distance. Therefore, the information processing device 100 is capable of reducing the processing load on the information processing device 100 in comparison with the Patent Reference 1.

### Second Embodiment

Next, a second embodiment will be described below. In the second embodiment, the description will be given mainly of features different from those in the first embodiment. In the second embodiment, the description is omitted fox features in common with the first embodiment.

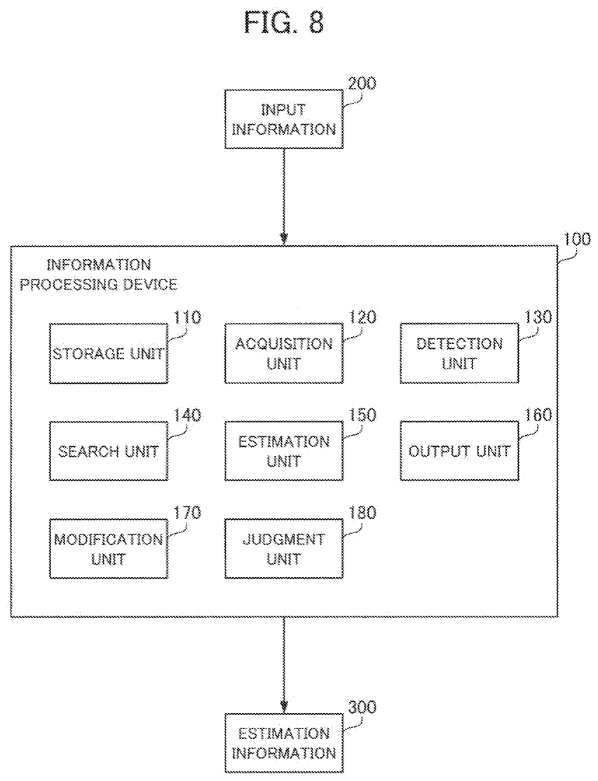

FIG. 8 is a block diagram showing functions of an information processing device in the second embodiment. The information processing device 100 further includes a modification unit 170 and a judgment unit 180.

Part or all of the modification unit 170 and the judgment unit 180 may be implemented by a processing circuitry. Further, part or all of the modification unit 170 and the judgment unit 180 may be implemented as modules of a program executed by the processor 101.

Details of the functions of the modification unit 170 and the judgment unit 180 will be described later.

Next, a process executed by the information processing device 100 will be described below by using a flowchart.

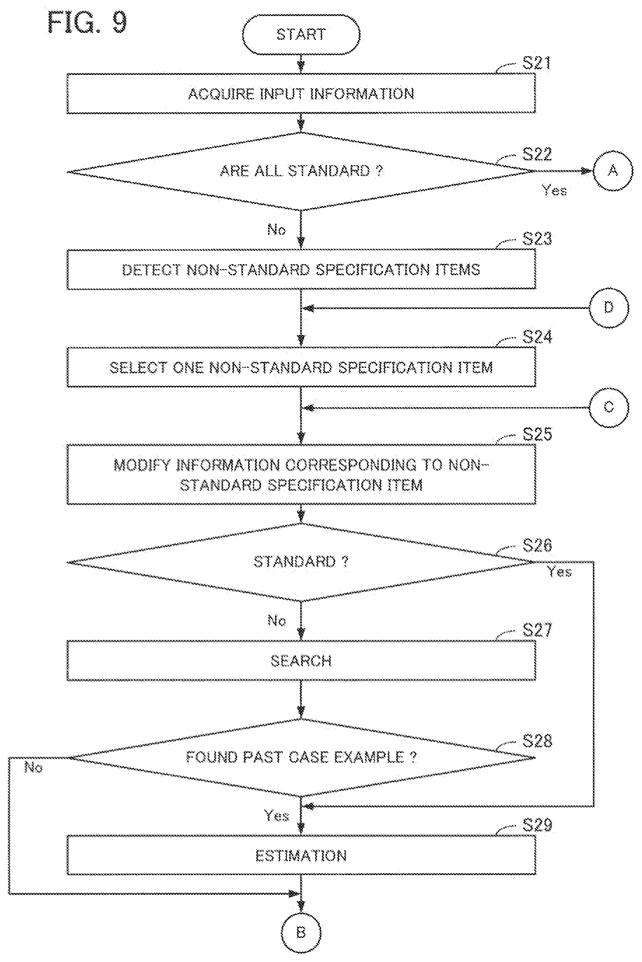

FIG. 9 is flowchart (No. 1) showing an example of the process executed by the information processing device in the second embodiment.

(Step S21) The acquisition unit 120 acquires the input information 200. It is assumer here that the input information 200 includes values corresponding respectively to the specification items A, B and C.

(Step S22) The detection unit 130 judges whether all of the values corresponding respectively to the specification items A, B and C indicated by the input information 200 are standard or not based on the standard judgment table 111.

When all of the values are standard, the estimation unit 150 estimates at least one of the cost and the work period based on at least one of the standard cost and the standard work period that have been previously. Then, the process advances to step S33. When at least one of the values is not standard, the process advances to step S23.

(Step S23) The detection unit 130 detects one of more non-standard specification items out of the specification items A, B and C indicated by the input information 200. The detected non-standard specification items are assumed to be the specification items B and C.

(Step S24) The detection unit 130 selects one non-Standard specification item from the detected non-standard specification. For example, the detection unit 130 selects the specification item B.

(Step S25) The modification unit 170 modifies the information corresponding to the selected non-standard specification item. Fox example, when the information corresponding to the specification item B (i.e., the selected non-standard specification item) indicated by the input information 200 is “500”, the modification unit 170 modifies “500” to “300”.

(Step S26) The judgment unit 180 judges whether the modified information is standard or not based on the standard judgment table 111. For example, the judgment unit 180 judges whether “300” corresponding to the specification item B is standard or not based on the standard judgment table 111.

When the modified information is standard, the process advances to step S29. When the modified information is non-standard, the process advances to step S27.

(Step S27) The search unit 140 searches for the past case examples regarding the non-standard specification item by using the past case example table 112. For example, the search unit 140 finds the specification Item B in the case example 1 and the specification item B in the case example 2.

(Step S28) The search unit 140 judges whether or not a past case example has been found by the search. When a past case example has been found by the search, the process advances to the step S29. When no past case example has been found by the search, the process advances to step S31.

(Step S29) When the step S29 is executed after the step S28, the estimation unit 150 estimates at least one of the cost regarding the selected non-standard specification item and the work period regarding the selected non-standard specification item based on the modified information (e.g., “300”) and the past case example found by the search.

When the step S29 is executed after the step S26, the estimation unit 150 estimates at least one of the cost and the work period based on at least one of the standard cost and the standard work period.

Then, the process advances to the step S31.

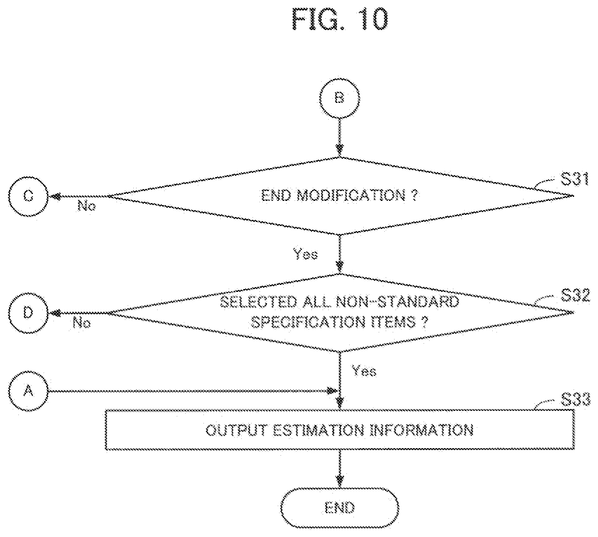

FIG. 10 is a flowchart (No. 2) showing the example of the process executed by the information processing device in the second embodiment.

(Step S31) The judgment unit 180 judges whether or not the modification of the information corresponding to the selected non-standard specification item should be ended. When the modification should be ended, the process advances to step S32. When the modification should not be ended, the process advances to the step S25. For example, in the step S25, the modification unit 170 modifies “500” to a value other than “300”.

(Step S32) The judgment unit 180 judges whether or not all of the non-standard specification items have been selected. For example, when the specification items B and C have been selected in the step S24, the judgment unit 180 judges that all of the non-standard specification items have been selected. When the specification item C has not been selected in the step S24, for example, the judgment unit 180 judges that there exists a non-standard specification item that has not been selected yet.

When all of the non-standard specification items have been selected, the process advances to the step S33. When there exists a non-standard specification item that has not been selected yet, the process advances to the step S24.

(Step S33) When the step S33 is executed after the step S32, the output unit 160 outputs the estimation information 300 indicating the estimation at the time when the information corresponding to the specification item was modified. For example, by viewing the estimation information 300, the user can learn at least one of the cost and the work period at the time when the information (i.e., the information corresponding to the specification item) included in the input information 200 was modified.

When the step S33 is executed after the step S22, the output unit 160 outputs the estimation information 300 as the information obtained by the estimation.

According to the second embodiment, the information processing device 100 is capable of outputting at least one of the cost and the work period at the time when the information corresponding to the non-standard specification item was modified.

Further, it is also possible for the estimation unit 150 to perform the estimation by using a learned model similarly to the first embodiment. Specifically, when the result of the search does not include information that is the same as the information modified in the step S25, the estimation unit 150 estimates at least one of the cost and the work period by using the modified information and the learned model. The information processing device 100 is capable of estimating at least one of a precise cost and a precise work period by using the leaned model.

Features in the embodiments described above can be appropriately combined with each other.

### DESCRIPTION OF REFERENCE CHARACTERS

100: information processing device, 101: processor, 102: volatile storage device, 103: nonvolatile storage device, 110: storage unit, 111: standard judgment table, 112: past case example table, 120: acquisition unit, 130: detection unity 140: search unit, 150: estimation unit, 160: output unit, 170: modification unit, 180: judgment unit, 200: input information, 300: estimation information

What is claimed is:

1. An information processing device comprising:
acquiring circuitry to acquire input information indicating correspondence relationship between a plurality of items regarding one or more products and a plurality of pieces of information, standard judgment information as information indicating a standard of each of the plurality of items, and past case example information as information indicating a past case example regarding each of the plurality of items;
detecting circuitry to detect a non-standard item, as an item in which corresponding information is non-standard, out of the plurality of items based on the standard judgment information and the plurality of pieces of information;
searching circuitry to search for a past case example regarding the non-standard item by using the past case example information;
estimating circuitry; and
outputting circuitry,
wherein
each of a plurality of past casa examples included in the past case example information includes at least one of a cost regarding a corresponding item and a work period regarding the corresponding item,
the estimating circuitry estimates at least one of the cost regarding the non-standard item and the work period regarding the non-standard item based on the past case example found by the search, and
the outputting circuitry outputs estimation information as information obtained by the estimation.

2. The information processing device according to claim 1, wherein
the acquiring circuitry acquires a learned model, and
when a result of the search does not include information that is same as information corresponding to the non-standard item, the estimating circuitry estimates at least one of the cost and the work period by using the information corresponding to the non-standard item and the leaned model.

3. An information processing device comprising:
acquiring circuitry to acquire input information indicating correspondence relationship between a plurality of items regarding one or more products and a plurality of pieces of information, standard judgment information as information indicating a standard of each of the plurality of items, and past case example information as information indicating a past case example regarding each of the plurality of items;
detecting circuitry to detect a non-standard item, as an item in which corresponding information is non-standard, out of the plurality of items based on the standard judgment information and the plurality of pieces of information;
modifying circuitry to modify information corresponding to the non-standard item;
searching circuitry;
estimating circuitry; and
outputting circuitry, wherein
when the modified information is non-standard based on the standard judgment information, the searching circuitry searches for the past case example regarding the non-standard item by using the past case example information,
the estimating circuitry estimates at least one of a cost regarding the non-standard item and a work period regarding the non-standard item based on the modified information and the past case example found by the search, and
the outputting circuitry outputs estimation information as information obtained by the estimation.

4. The information processing device according to claim 3, wherein
the acquiring circuitry acquires a learned model, and
when a result of the search does not include information that is same as the modified information, the estimating circuitry estimates at least one of the cost and the work period by using the modified information and the leaned model.

5. An information processing method performed by an information processing device, the information processing method comprising:
acquiring input information indicating correspondence relationship between a plurality of items regarding one or more products and a plurality of pieces of information, standard judgment information as information indicating a standard of each of the plurality of items, and past case example information as information indicating a past case example regarding each of the plurality of items;
detecting a non-standard item, as an item in which corresponding information is non-standard, out of the plurality of items based on the standard judgment information and the plurality of pieces of information;
searching for a past case example regarding the non-standard item by using the past case example information;
estimating at least one of the cost regarding the non-standard item and the work period regarding the non-standard item based on the past case example found by the search; and
outputting estimation information as information obtained by the estimation,
wherein
each of a plurality of past case examples included in the past case example information includes at least one of a cost regarding a corresponding item and a work period regarding the corresponding item.

6. An information processing method performed by an information processing device, the information processing method comprising:
acquiring input information indicating correspondence relationship between a plurality of items regarding one or more products and a plurality of pieces of information, standard judgment information as information indicating a standard of each of the plurality of items, and past case example information as information indicating a past case example regarding each of the plurality of items;
detecting a non-standard item, as an item in which corresponding information is non-standard, out of the plurality of items based on the standard judgment information and the plurality of pieces of information;
modifying information corresponding to the non-standard item;
searching for the past case example regarding the non-standard item by using the past case example information when the modified information is non-standard based on the standard judgment information;
estimating at least one of a cost regarding the non-standard item and a work period regarding the non-standard item based on the modified information and the past case example found by the search; and
outputting estimation information as information obtained by the estimation.

7. An information processing comprising:
a processor to execute a program; and
a memory to store the program which, when executed by the processor, performs processes of,
acquiring input information indicating correspondence relationship between a plurality of items regarding one or more products and a plurality of pieces of information, standard judgment information as information indicating a standard of each of the plurality of items, and past case example information as information indicating a past case example regarding each of the plurality of items;
detecting a non-standard item, as an item in which corresponding information is non-standard, out of the plurality of items based on the standard judgment information and the plurality of pieces of information;
searching for a past case example regarding the non-standard item by using the past case example information;
estimating at least one of the cost regarding the non-standard item and the work period regarding the non-standard Item based on the past case example found by the search; and
outputting estimation information as information obtained by the estimation,
wherein
each of a plurality of past case examples included in the past case example information includes at least one of a cost regarding a corresponding item and a work period regarding the corresponding item.

8. An information processing device comprising:
a processor to execute a program; and
a memory to store the program which, when executed by the processor, performs processes of,
acquiring input information indicating correspondence relationship between a plurality of items regarding one or more products and a plurality of pieces of information, standard judgment information as information indicating a standard of each of the plurality of items, and past case example information as information indicating a past case example regarding each of the plurality of items;
detecting a non-standard item, as an item in which corresponding information is non-standard, out of the plurality of items based on the standard judgment information and the plurality of pieces of information;
modifying information corresponding to the non-standard item;
searching for the past case example regarding the non-standard item by using the past case example information when the modified information is non-standard based on the standard judgment information;
estimating at least on of a cost regarding the non-standard item and a work period regarding the non-standard item based on the modified information and the past case example found by the search; and
outputting estimation information as information obtained by the estimation.
